(19) United States
(12) Patent Application Publication
(10) Pub. No.: US 2009/0038470 A1
(43) Pub. Date: Feb. 12, 2009

(54) HYDRO-PNEUMATIC PRESSURE TRANSFORMATION DEVICE AND METHOD FOR OPERATION

(75) Inventors: Bernd SCHAD, Ebersbach (DE); Georg GERNERT, Kisslegg (DE); Werner MOTZ, Kissleg (DE); Eberhard DIETZEL, Weingarten (DE); Eugen RAPP, Berg (DE)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: TOX PRESSOTECHNIK GMBH & CO. KG, Weingarten (DE)

(21) Appl. No.: 12/187,073

(22) Filed: Aug. 6, 2008

(30) Foreign Application Priority Data
Aug. 6, 2007 (DE) 102007036844.7

(51) Int. Cl. F15B 11/072

(52) U.S. Cl. 91/4 R

(57) ABSTRACT

Proposed is a hydro-pneumatic pressure transformation device with a working piston (3) and a transformer piston (17) for transforming the pressure exerted upon the working piston (3), wherein the transformer piston (17) features a working stroke chamber (19) for the power stroke and a return stroke chamber (15) for the return stroke, and wherein the working stroke chamber (19) can be subjected to an operating pressure for the power stroke. According to the invention, pressurization means are provided for changing over the return stroke chamber (15) between a low pressure that lies at least approximately in the range of atmospheric pressure or at atmospheric pressure and an intermediate pressure that lies between the low pressure and the operating pressure during the course of the power stroke and the return stroke. A method for operating a hydro-pneumatic device is also proposed.

### FIELD OF THE INVENTION

The invention pertains to a hydro-pneumatic pressure transformation device as well as to a method for operating a hydro-pneumatic pressure device.

### BACKGROUND OF THE INVENTION

Hydro-pneumatic pressure transformation devices are already known in many different variations. Known devices usually feature a working piston and a transformer piston for transforming the pressure exerted upon the working piston, wherein the transformer piston dips into a hydraulic fluid. A storage piston is frequently provided that makes it possible to realize a quick motion of the working piston by displacing hydraulic fluid prior to a power stroke.

In one known device, a pressure spring is installed between the transformer piston and the storage piston. This pressure spring serves two functions. The first is realizing the return motion of the transformer piston when there is no longer any operating pressure acting upon the transformer piston. The second function of the spring is to constantly subject the storage piston to a spring pressure such that the hydraulic fluid volume situated in a storage chamber behind the storage piston is also subjected to the corresponding pressure. This means that when the hydraulic fluid volume does not have to be subjected to pneumatic pressure from the side of the storage piston, the air consumption is lowered because no compressed air is required for realizing the return motion of the transformer piston.

In another device, instead of inserting a pressure spring between the transformer piston and the storage piston, a pneumatic return motion of the transformer piston is realized and the storage piston is subjected to pneumatic pressure. To this end, a transformer piston return stroke chamber is subjected to a reduced pneumatic pressure. In accordance with the function of the mechanical pressure spring, this pressure may also be referred to as a “pneumatic spring.” In one embodiment, the same “pneumatic spring pressure” also acts upon the storage piston and maintains the hydraulic reservoir under prestress. Analogous to the mechanical pressure spring, the “pneumatic spring pressure” permanently acts upon the transformer piston and the storage piston, wherein the pressure always remains constant independently of the moving state of the piston in contrast to the mechanical spring.

Given the state of the art, a hydro-pneumatic pressure transformation device that operates in a more effective fashion would be an important improvement in the art.

### BRIEF SUMMARY OF THE INVENTION

The invention involves a hydro-pneumatic pressure transformation device with a working piston and a transformer piston for transforming the pressure exerted upon the working piston. The transformer piston features a working stroke chamber for the power stroke and a return stroke chamber for the return stroke. The working stroke chamber is subjected to an operating pressure for the power stroke. The essential aspect of the invention can be seen in that pressurization means are provided for varying the return stroke chamber between a low pressure that lies at least in the range of atmospheric pressure or atmospheric pressure plus an intermediate pressure that lies between the low pressure and the operating pressure during the course of the power stroke and the return stroke.

### BRIEF DESCRIPTION OF THE DRAWINGS

FIG. 1 is a sectional view of a hydro-pneumatic pressure transformation device.

### DETAILED DESCRIPTION OF THE INVENTION

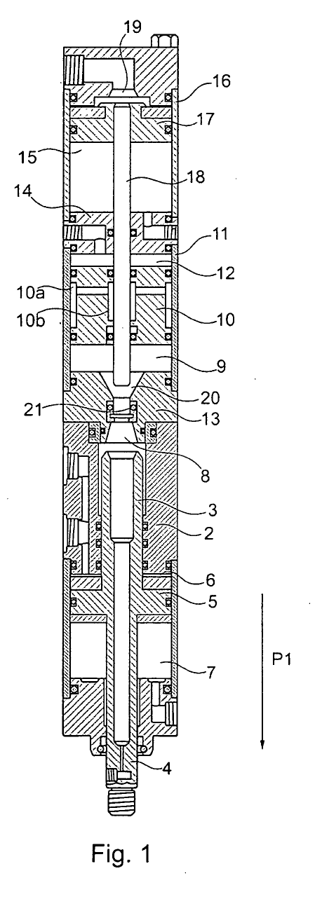

FIG. 1 shows a hydro-pneumatic pressure transformation device 1 that is also referred to as a pressure transformer 1. The pressure transformer 1 features a housing 2, in which a working piston 3 is arranged in a displaceable and radially sealed fashion. The working piston 3 that is situated in an initial position in FIG. 1 is provided with a piston rod 4 that protrudes outward through the housing 2. In addition, the working piston 3 features an auxiliary piston 5 that can also be moved in the housing 2 together with the working piston 3 in a radially sealed fashion.

The auxiliary piston 5 separates two pneumatic chambers 6 and 7 from one another. If a corresponding pressure is present in the pneumatic chamber 6, the working piston 3 is pushed downward in the direction indicated by the arrow P1.

The working piston 3 defines a work chamber 8 that is hydraulically connected to a storage chamber 9 situated on top thereof via a constriction in a radially sealed fashion. The storage chamber 9 is filled with hydraulic fluid and acted upon by a displaceable storage piston 10. The storage piston 10 is radially sealed and axially displaceable relative to a casing 11, wherein the casing 11 encompasses the circumference of a control chamber 12 situated above the storage piston 10. The control chamber 12 can be subjected to pneumatic pressure. In order to optimize a gas-liquid separation between the control chamber 12 and the storage chamber 9, the surface area of the storage piston 10 is provided with a first annular groove 10a and a second annular groove 10b connected thereto, wherein the two annular grooves 10a, 10b are connected to one another by means of a transverse bore. The inner annular groove 10b is realized on an inside wall of an inner bore that centrally extends through the storage piston 10.

In order to seal sections due to the motion of piston sections of the pressure transformer 1, additional seals are provided that are not described in greater detail, e.g., circumferential seals on the surface area or the inside wall of the central bore of the storage piston 10.

The casing 11 is closed by a housing part 13 of the housing 2 in the region of the storage chamber 9 and by a separating wall 14 in the region of the control chamber 12. A stationary separating wall 14 is positioned between the control chamber 12 and another pneumatic chamber 15 that is surrounded by another casing 16, wherein a movable plunger piston 18 of a drive piston or transformer piston 17 extends through this stationary separating wall in a radially sealed fashion. The plunger piston 18 is rigidly and centrally arranged on the transformer piston 17 and extends downward from one side thereof, wherein the plunger piston 18 has a significantly smaller outside diameter than the transformer piston 17. The plunger piston 18 can be displaced against the hydraulic pressure in the work chamber 8.

The plunger piston 18 extends through the separating wall 14 and the storage piston 10 and protrudes into the storage chamber 9 with its free end in the initial position, as shown in FIG. 1. The transformer piston 17 and therefore the plunger piston 18 are pneumatically displaced by subjecting a drive chamber 19 situated adjacent to the transformer piston to pressure. This makes it possible to pressurize the drive chamber 19 in such a way, e.g., for a high-pressure cycle, that the plunger piston 18 penetrates into a constricted section or into a connecting bore 20 leading from the storage chamber 9 to the work chamber 8. As the front section of the plunger piston 18 penetrates into the connecting bore 20, the connection between the storage chamber 9 and the work chamber 8 is interrupted with the aid of a radial seal 21. As the stroke of the plunger piston 18 continues in the direction of the arrow P1, the plunger piston 18 penetrates further into the work chamber 8 such that a comparatively high working pressure is generated in the work chamber 8 due to the relatively small plunger piston 18 diameter. This pressure corresponds to the transformation ratio between the working surface of the transformer piston 17 and the working surface of the plunger piston 18 based on the pneumatic pressure acting upon the transformer piston 17. This makes it possible to generate a high force on the piston rod 4 with the working piston 3.

A comparatively lower pneumatic pressure is required in the drive chamber 19 for the return stroke of the plunger piston 18. This makes it possible to return the transformer piston 17 into the initial position illustrated in FIG. 1 together with the plunger piston 18. During this process, hydraulic fluid is displaced out of the work chamber 8 and into the storage chamber 9 due to the return motion of the working piston 3. In this case, the working piston 3 is also driven by the auxiliary piston 5 and also moved into the initial position according to FIG. 1 by a suitable pneumatic pressure present in the pneumatic chamber 7.

The inventive arrangement can basically be realized on a hydro-pneumatic pressure transformation device with structurally connected working section and transformer section as shown in FIG. 1, as well as on systems in which the two functions are structurally separated and connected to one another by means of high-pressure lines.

The force required for resetting the transformer piston 17 can be generated by introducing a pneumatic pressure into the transformer piston return stroke chamber or the pneumatic chamber 15, respectively. To this end, the pressure transformer is respectively provided with an inventive pneumatic spring and a pneumatic spring control. Since the full pneumatic operating pressure is not required for resetting the transformer piston 17, the pneumatic pressure in the pneumatic chamber 15 or a so-called pneumatic spring pressure is reduced in accordance with the invention, e.g., with the aid of a (not-shown) pressure regulator. This makes it possible to drastically reduce the overall air consumption of the pressure transformer 1 in comparison with known devices.

It is advantageous, in particular, that no additional pneumatic connection is required for the pneumatic supply of the pressure regulator because the pressure regulator is pneumatically supplied by a forward stroke connection and a return stroke connection, for example, by means of an OR control.

Depending on the design of the control, it would be possible, in principle, to also subject the storage piston 10 to the same pneumatic pressure or pneumatic spring pressure as that present in the return stroke chamber or pneumatic chamber 15 such that a hydraulic reservoir or the hydraulic fluid accommodated in the storage chamber 19 is maintained under reduced pre-stress. Alternatively, the storage piston 10 may also be subjected to the full operating pressure and thusly maintained under increased pre-stress.

The proposed pneumatic control is not illustrated in the figure and can promote the flow of hydraulic fluid from the storage chamber 9 into the work chamber 8 if the storage piston 10 is subjected to a comparatively reduced pneumatic pressure or pneumatic spring pressure, respectively. To this end, the (not-shown) inventive pressurization means and the pneumatic control may be realized in such a way that a corresponding valve circuit subjects the storage piston 10 to a comparatively high pneumatic pressure or a maximum operating pressure during the quick-motion stroke and the power stroke such that the storage piston can be maintained under increased pre-stress.

This change-over is not required if the storage piston 10 is permanently subjected to the full operating pressure.

In the inventive circuit concept, the pneumatic spring effect in the transformer piston return stroke chamber and in the pneumatic chamber 15 can also be switched off during the power stroke. This makes it possible to maximally utilize the available pressing force on the pressure transformer 1 with a pneumatic spring control.

This also makes it possible to significantly increase the power stroke in comparison with mechanical spring force arrangements, as well as in comparison with pneumatic spring arrangements in which the pneumatic spring force is not switched off during the power stroke.

When in operation, the low pressure is preferably applied during the power stroke. If an identical intermediate pressure would be maintained during the power stroke, this intermediate pressure would counteract a pneumatic pre-stroke pressure and thus reduce the piston force of the transformer piston 17. If, however, the return stroke chamber 19 of the transformer piston 17 is changed over to low pressure during the power stroke, the overall pressing force on the working piston 3 can be significantly increased during the power stroke in comparison with a control in which the pressure in the return stroke chamber 19 of the transformer piston 17 is not reduced. If the pressure is changed over, e.g., to atmospheric pressure, the stroke force can be increased by 10% to 20% based on an intermediate pressure, e.g., of 0.8 bar above atmospheric pressure.

Due to the option of completely switching off the pressure in the return stroke chamber 19 of the transformer piston 17, it is also possible to eliminate a secondary ventilation of the “pneumatic spring chamber,” i.e., of the return stroke chamber 19 of the transformer piston 17.

The air consumption is still significantly reduced in comparison with a variation in which the transformer piston return stroke chamber 19 is subjected to the full operating pressure during the return stroke.

The intermediate pressure preferably lies in the range between 0.5 and 2 bars above atmospheric pressure, particularly at 0.8 bars above atmospheric pressure. Such a pressure ensures a reliable return motion of the transformer piston 17, wherein a still acceptable air consumption is realized if this intermediate pressure is completely switched off for the forward stroke, i.e., the power stroke, such that a pressure difference of 0.8 bar is created.

Another essential aspect of the invention is that a control chamber of a storage piston for realizing a quick motion of the working piston 3 by displacing hydraulic fluid prior to the power stroke with the aid of the pressurization means is always subjected to a constant, identical pressure level that is higher than the intermediate pressure in the regular operating mode. This measure not only makes it possible to realize a quick-motion stroke because a comparatively high air pressure is present in the control chamber 12 of the storage piston 10, but also ensures that the hydraulic fluid in the storage chamber 9, upon which the storage piston 10 acts, is subjected to a constant pressure. This reduces the quantity of air introduced into the hydraulic fluid and a possibly occurring oil leak is reduced such that longer maintenance cycles can be realized. The control chamber 12 is preferably subjected to the operating pressure such that not only a maximum quick-motion stroke velocity, but also a pressurization of the hydraulic fluid with a comparatively high pressure level is realized.

In this embodiment, it is preferred, however, that the pressurization means feature a mechanical change-over option that enables the user to manually change over the pneumatic operating pressure exerted upon the storage piston 10 to the intermediate pressure, e.g., during maintenance procedures. During the initial quick-motion stroke after the ventilation process, a corresponding change-over valve preferably is automatically reset into the initial position such that the storage piston 10 is once again subjected to the operating pressure. Consequently, faulty operation by the user during the regular stroke mode can be prevented due to this automatic reset feature.

In an integrated accommodation of the transformer piston 17 and the working piston 3 in one housing, the working piston 3 can be reset when the storage piston 10 is subjected to the operating pressure by applying the same pressure in a return stroke chamber 15 of the working piston 3 if, as it is the case in numerous embodiments, the working piston 3 penetrates into the hydraulic fluid reservoir situated in between with a significantly smaller surface than the return stroke surface of the working piston 3, upon which the operating pressure acts. The surface ratio ensures the return stroke of the storage piston 10.

There also exist embodiments, in which such a surface ratio is not provided. In such instances, it is preferred that the pressurization means can change over the pressure in the control chamber 12 of the storage piston 10 between the operating pressure during the quick motion and the intermediate pressure during a return motion in order to ensure a reliable return stroke of the storage piston 10.

In another particularly preferred embodiment of the invention, the device features a compressed air connection on a quick-motion stroke chamber and a compressed air connection on a return stroke chamber 15 of the working piston 3 in order to be externally connected. Other external connections are preferably not required. All other required connecting lines and terminals are advantageously integrated into the device. For example, a single valve block is provided that can be arranged on the device, e.g., flanged thereon, in order to realize the complex pneumatic connections on the device required for the control technology. This valve block only needs to be provided, e.g., with two terminals. This makes it possible to minimize connecting errors.

It would also be conceivable to realize an arrangement, in which only one compressed air connection on the device needs to be connected. In this case, the forward stroke and the return stroke are preferably realized by providing an electrically switchable valve.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A hydro-pneumatic pressure transformation device comprised of:
a working piston (3) and a transformer piston (17) aligned within a housing;
said transformer piston (17) having a working stroke chamber (19) for the power stroke and a return stroke chamber (15) for the return stroke, wherein the working stroke chamber (19) is subjected to an operating pressure during the power stroke; and
pressurization means connected to the return stroke chamber (15) for varying the pressure in the return stroke chamber (15) between a pressure of approximately atmospheric pressure, and an atmospheric pressure plus an intermediate pressure, where said intermediate pressure lies between the low pressure and the operating pressure during the course of the power stroke and the return stroke.

2. The hydro-pneumatic pressure transformation device of claim 1, wherein the intermediate pressure lies in the range between 0.5 and 2 bar above atmospheric pressure.

3. The hydro-pneumatic pressure transformation device of claim 1, wherein a control chamber (12) of a storage piston (10) is subjected to an identical pressure level that lies above the intermediate pressure in a regular mode.

4. The hydro-pneumatic pressure transformation device of claim 3, wherein the control chamber (12) is always subjected to the operating pressure in a regular mode.

5. The hydro-pneumatic pressure transformation device of claim 1, wherein the control chamber (12) of the storage piston (10) is changed over between the operating pressure during the quick motion and the intermediate pressure during a return motion with the aid of the pressurization means.

6. The hydro-pneumatic pressure transformation device of claim 1, wherein the device features a pressure connection on a quick-motion stroke chamber (6) and a pressure connection on a return stroke chamber (7) of the working piston (3) in order to be externally connected.

7. The hydro-pneumatic pressure transformation device of claim 1, wherein only one compressed air connection is provided.

8. A method for operating a hydro-pneumatic device having a working piston (3) and a transformer piston (17) for transforming the pressure exerted upon the working piston (3), wherein the transformer piston (17) features a working stroke chamber (19) for a power stroke and a return stroke chamber (15) for a return stroke, and wherein the working stroke chamber (19) is subjected to an operating pressure for the power stroke, the method comprised of:
varying the pressure in the return stroke chamber (15) between a low pressure that lies at least approximately in the range one of an atmospheric pressure and an atmospheric pressure plus and an intermediate pressure, where said intermediate pressure lies between the low pressure and the operating pressure during the course of the power stroke and the return stroke.

9. The method of claim 8 further comprising:
subjecting a control chamber (12) of a storage piston (10) for realizing a quick motion of the working piston (3) by displacing hydraulic fluid to an identical pressure level that lies above the intermediate pressure in a regular mode.

10. The method of claim 9 further comprising:
varying the pressure in the control chamber (12) of the storage piston (10) between the operating pressure during the quick motion and the intermediate pressure during a return motion.

11. The method of claim 10 further comprising:
automatically resetting the pressure acting on the storage piston (1) to the initial pressure during the next quick-motion stroke of the working piston (3).
